(19) United States
(12) Patent Application Publication
(10) Pub. No.: US 2025/0271077 A1
(43) Pub. Date: Aug. 28, 2025

(54) METHOD OF PNEUMATICALLY OPERATING A VALVE USING GAS WITHOUT EMITTING GREENHOUSE EMISSIONS

(71) Applicant: Dallas Chism Watson, Guthrie, OK (US)

(72) Inventor: Dallas Chism Watson, Guthrie, OK (US)

(21) Appl. No.: 18/810,662

(22) Filed: Aug. 21, 2024

Related U.S. Application Data
(60) Provisional application No. 63/557,671, filed on Feb. 26, 2024.

(51) Int. Cl. F16K 31/42; F16K 31/122; F16K 31/126

(52) U.S. Cl. CPC F16K 31/423; F16K 31/122; F16K 31/126

(57) ABSTRACT

A valve apparatus for controlling the flow of fluid. The valve apparatus includes a valve having a valve body and a valve inlet for allowing fluid to flow into the valve body. The valve apparatus also includes a valve outlet for allowing fluid to flow out of the valve body and a rod element that selectively engages a seat to permit fluid to flow from the valve inlet to the valve outlet. The valve apparatus further includes a valve actuation apparatus for opening and closing the valve. A method of opening a closing a valve using high pressure motive gas. The method includes directing a high pressure motive gas to a valve apparatus to open and close a valve.

### CROSS-REFERENCE TO RELATED APPLICATIONS

The present application is a conversion of U.S. Provisional Application having U.S. Ser. No. 63/557,671, filed Feb. 26, 2024, which claims the benefit under 35 U.S.C. 119(e). The disclosure of which is hereby expressly incorporated herein by reference.

### STATEMENT REGARDING FEDERALLY SPONSORED RESEARCH OR DEVELOPMENT

Not applicable.

### BACKGROUND OF THE DISCLOSURE

### 1. Field of the Invention

The present disclosure generally relates to a valve apparatus that can be pneumatically actuated using a gas without emitting greenhouse emissions.

### 2. Description of the Related Art

During the production, transportation and processing of natural gas and oil, it is common practice to utilize readily available compressed natural gas to operate pneumatic actuated valves. These valves are typically operated by applying gas pressure to a single side of a diaphragm located within a chamber. Gas pressure is then released from the chamber allowing a spring to return the diaphragm to its original open or closed position. This release of gas is typically vented and/or exhausted to the atmosphere and/or to low pressure piping and/or vessels. Exhausting and/or venting these types of valves into a pressurized system is limited to the spring return strength and diaphragm strength which limits the exhaust pressure into a contained environment.

Accordingly, there is a need for a valve apparatus that can be operated by high pressure gases without venting the gases to the surrounding atmosphere.

### SUMMARY OF THE DISCLOSURE

The present disclosure is directed to a valve apparatus for controlling the flow of fluid. The valve apparatus includes a valve having a valve body and a valve inlet for allowing fluid to flow into the valve body. The valve apparatus also includes a valve outlet for allowing fluid to flow out of the valve body and a rod element that selectively engages a seat to permit fluid to flow from the valve inlet to the valve outlet. The valve apparatus further includes a valve actuation apparatus for opening and closing the valve. The present disclosure is also directed to a method of opening a closing a valve using high pressure motive gas. The method includes directing a high pressure motive gas to a valve apparatus to open and close a valve.

### BRIEF DESCRIPTION OF THE DRAWINGS

FIG. 1A is a cross-sectional view of one embodiment of a valve apparatus in a first position and constructed in accordance with the present disclosure.

FIG. 1B is a cross-sectional view of the valve apparatus shown in FIG. 1A in a second position and constructed in accordance with the present disclosure.

FIG. 2A is a cross-sectional view of another embodiment of a valve apparatus in a first position and constructed in accordance with the present disclosure.

FIG. 2B is a cross-sectional view of the valve apparatus shown in FIG. 2A in a second position and constructed in accordance with the present disclosure.

### DETAILED DESCRIPTION OF THE DISCLOSURE

The present disclosure is related to a valve apparatus for controlling the flow of a production fluid, such as a liquid or a gas, that can be opened and closed using a single source of high-pressure motive gas. The high-pressure motive gas can be a gas that is harmful to the environment, and it is preferred to prevent release of the gas into the atmosphere. Examples of these harmful gases include, but are not limited to, methane, natural gas, carbon dioxide, hydrogen sulfide, carbon monoxide, etc. A high-pressure source of one of these environmentally harmful gases could be found in various industrial settings. A typical source of one of these harmful gases could be natural gas produced from an oil and gas well.

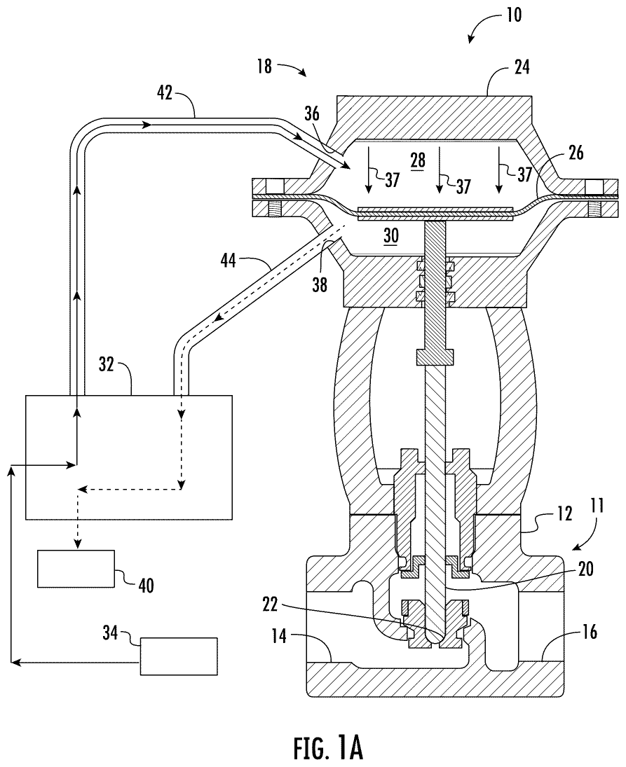

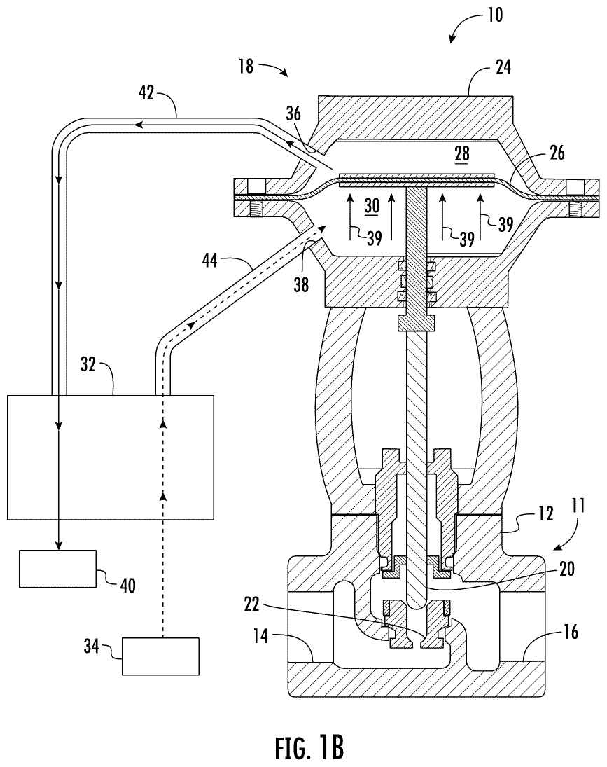

Referring now to FIGS. 1A-1B, shown therein is one embodiment of a valve apparatus 10 that includes a valve 11 that includes a valve body 12 with an inlet 14 for receiving a production fluid (liquid or gas) to the valve body 12 and an outlet 16 for permitting the production fluid to exit the valve body 12. The valve apparatus 10 can also include a valve actuation apparatus 18 for opening and closing the valve 11 to permit fluids to flow therethrough or to prohibit the flow of fluids therethrough. The valve actuation apparatus 18 can be linked to the valve 11 via a rod element 20. The rod element 20 has a first and second position in the valve body 12. In the first position, the rod element 20 is engaged with a seat 22 to prevent flow of the production fluid through the valve body 12. In the second position, the rod element 20 is disengaged from the seat 22 and permits the production fluid to flow through the valve body 12.

The rod element 20 can be shifted between the first and second positions by the valve actuation apparatus 18. In one embodiment, the valve actuation apparatus 18 includes a compression chamber 24 with a diaphragm 26 disposed therein that is connected to the rod element 20. Due to the connection between the rod element 20 and the diaphragm 26, the rod element 20 moves between the first and second positions as the diaphragm 26 is forced in a first direction and forced in a second direction. The compression chamber 24 can have a first compression side 28 and a second compression side 30. The valve actuation apparatus 18 can include a switch valve 32 that can direct a high pressure motive gas from a high pressure motive gas source 34 to the first compression side 28 via a first gas passageway 36 in the compression chamber 24. When the switch valve 32 directs the high pressure motive gas to the first compression side 28 of the diaphragm 26, the diaphragm 26 forces the rod element 20 in the direction shown by arrows 37 and into the seat 22 to maintain closure of the valve 11. The switch valve 32 can prevent the high pressure motive gas from decompressing on the first compression side 28 of the diaphragm 26.

When desired, the switch valve 32 can be actuated to direct the high pressure motive gas to the second compression side 30 via a second gas passageway 38 disposed in the compression chamber 24. Once the high pressure motive gas is delivered to the second compression side 30 of the diaphragm 26, the diaphragm 26 is flexed in an opposite direction shown by arrows 39 which causes the rod element 20 to move away from the seat 22 to permit fluid to flow through the valve 11. When desired, the switch valve 32 can cause the high pressure motive gas to be redirected to the first compression side 28 of the diaphragm 26 to force the rod element 20 back into the seat 22 to close the valve 11.

When the high pressure motive gas is directed into one of the compression sides 28 or 30 of the diaphragm 26, not only is the diaphragm 26 flexed a specific direction, but the gas on the other compression side of the diaphragm 26 is now a low pressure exhaust gas. The low pressure exhaust gas is forced back through the respective gas passageway 36 or 38 and to an exhaust gas collection apparatus 40, which can be a vent line, vessel or any type of apparatus capable of receiving the exhaust gas. The low pressure exhaust gas can be handled and/or processed in any desirable manner. To be clear, when the switch valve 32 directs high pressure motive gas to the first compression side 28 of the diaphragm 26 via the first gas passageway 36, low pressure exhaust gas will be forced to exit the second compression side 30 of the compression chamber 24 via the second gas passageway 38. Similarly, when the switch valve 32 directs high pressure motive gas to the second compression side 30 of the diaphragm 26 via the second gas passageway 38, low pressure exhaust gas will be forced to exit the first compression side 28 of the compression chamber 24 via the first gas passageway 36.

The switch valve 32 can be any type of valve device capable of directing a first gas (i.e., high pressure motive gas) from the motive gas source 34 to a first conduit 42 in fluid communication with the first gas passageway 36 and the first compression side 28 of the diaphragm 26 and switching to direct the first gas to a second conduit 44 in fluid communication with the second gas passageway 38 and the second compression side 30 of the diaphragm 26. The switch valve 32 can also be capable of directing a second gas (i.e., low pressure exhaust gas) from the first gas passageway 36 and the second gas passageway 38 to the exhaust gas collection apparatus 40. The switch valve 32 can be any type of valve device that can open a fluidic connection between the high pressure motive gas source 34 and the first gas passageway 36 of the compression chamber 24 and open a fluidic connection between the second gas passageway 38 and the exhaust gas collection apparatus 40 at essentially the same time. Similarly, the switch valve 32 can be any type of valve device that can open a fluidic connection between the high pressure motive gas source 34 and the second gas passageway 38 of the compression chamber 24 and open a fluidic connection between the first gas passageway 36 and the exhaust gas collection apparatus 40 at essentially the same time. The switch valve 32 can be a single apparatus or a collection of multiple apparatuses. Examples of switch valves can be 5/2 solenoid valves, multiple solenoid valves, such as 3/2 solenoid valves, used in conjunction and/or multiple solenoid spool valves used in conjunction.

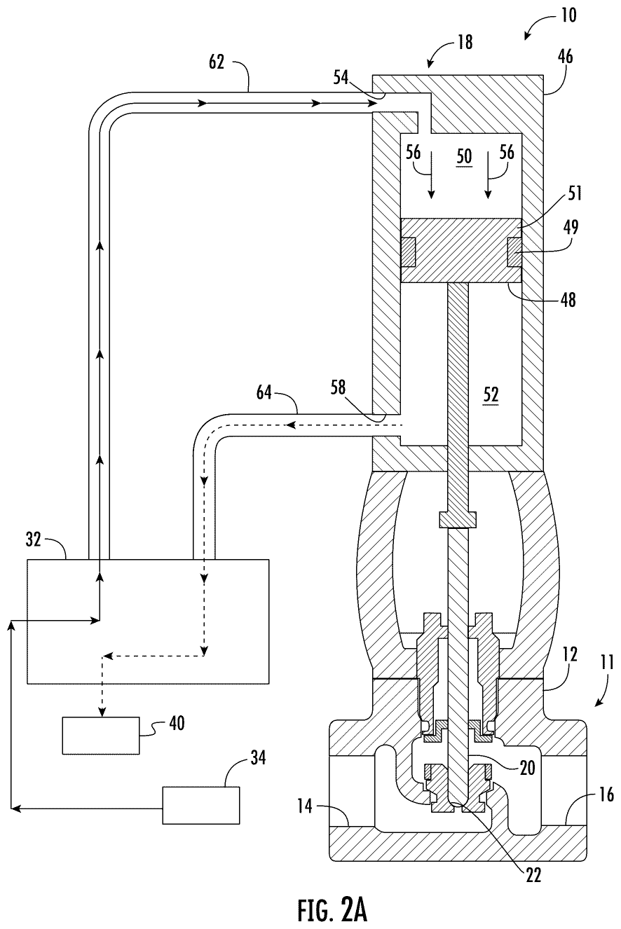

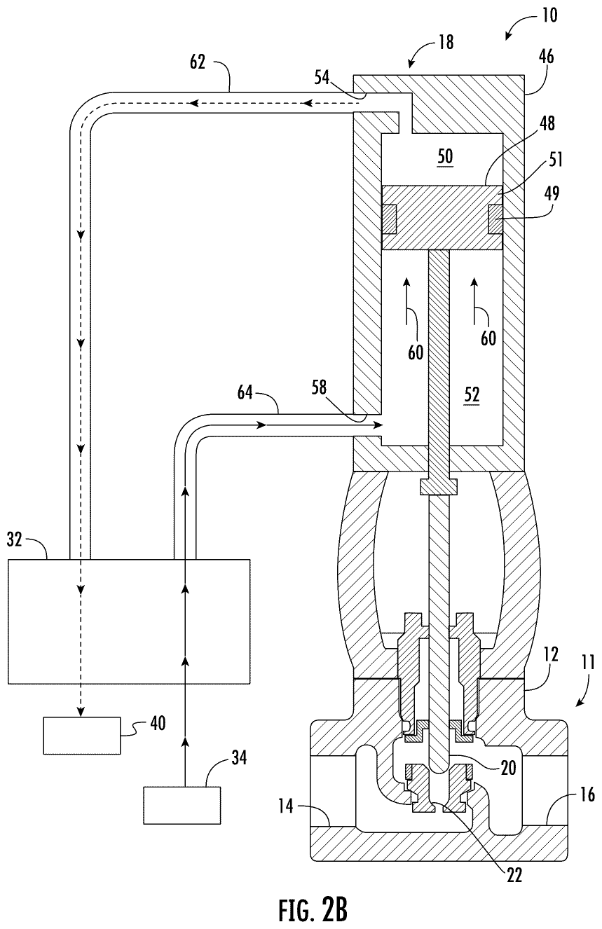

Referring now to FIGS. 2A and 2B, shown therein is another embodiment of the valve apparatus 10. In this embodiment, the valve actuation apparatus 18 includes a compression cylinder 46 with a piston 48 disposed therein that is connected to the rod element 20. The piston 48 can have a seal element 49 disposed on an outer side 51 of the piston 48 to seal one section of the compression cylinder 46 from another part of the compression cylinder 46. Due to the connection between the rod element 20 and the piston 48, the rod element 20 moves between the first and second positions as the piston 48 is forced in a first direction and forced in a second direction. The compression cylinder 46 can have a first compression side 50 and a second compression side 52. The switch valve 32 of the valve actuation apparatus 18 can direct the high pressure motive gas from the high pressure motive gas source 34 to the first compression side 50 via a first gas passageway 54 in the compression cylinder 46. When the switch valve 32 directs the high pressure motive gas to the first compression side 50 of the piston 48, the piston 48 forces the rod element 20 in the direction shown by arrows 56 and into the seat 22 to maintain closure of the valve 11. The switch valve 32 can prevent the high pressure motive gas from decompressing on the first compression side 50 of the piston 48.

When desired, the switch valve 32 can be actuated to direct the high pressure motive gas to the second compression side 52 via a second gas passageway 58 disposed in the compression cylinder 46. Once the high pressure motive gas is delivered to the second compression side 52 of the piston 48, the piston 48 is forced in an opposite direction shown by arrows 60 which causes the rod element 20 to move away from the seat 22 to permit fluid to flow through the valve 11. When desired, the switch valve 32 can cause the high pressure motive gas to be redirected to the first compression side 50 of the piston 48 to force the rod element 20 back into the seat 22 to close the valve 11.

When the high pressure motive gas is directed into one of the compression sides 50 and 52 of the piston 48, not only is the piston 48 forced to travel a specific direction, but the gas on the other compression side of the piston 48 is now a low pressure exhaust gas and is forced from that compression side. The low pressure exhaust gas is forced back through the respective gas passageway 54 or 58 and to the exhaust gas collection apparatus 40, which can be a vent line, vessel or any type of apparatus capable of receiving the exhaust gas. The low pressure exhaust gas can be handled and/or processed in any desirable manner. To be clear, when the switch valve 32 directs high pressure motive gas to the first compression side 50 of the piston 48 via the first gas passageway 54, low pressure exhaust gas will be forced to exit the second compression side 52 of the compression cylinder 46 via the second gas passageway 58. Similarly, when the switch valve 32 directs high pressure motive gas to the second compression side 52 of the piston 48 via the second gas passageway 58, low pressure exhaust gas will be forced to exit the first compression side 50 of the compression cylinder 46 via the first gas passageway 54.

The switch valve 32 for the embodiment shown in FIGS. 2A and 2B operates similarly to the switch valve 32 described herein. Therefore, the switch valve 32 can be any type of valve device capable of directing a first gas (i.e., high pressure motive gas) from the motive gas source 34 to a first conduit 62 in fluid communication with the first gas passageway 54 and the first compression side 50 of the piston 48 and switching to direct the first gas to a second conduit 64 in fluid communication with the second gas passageway 58 and the second compression side 52 of the piston 48. The switch valve 32 can also be capable of directing a second gas (i.e., low pressure exhaust gas) from the first gas passageway 54 and the second gas passageway 58 to the exhaust gas collection apparatus 40. The switch valve 32 can be any type of valve device that can open a fluidic connection between the high pressure motive gas source 34 and the first gas passageway 54 of the compression cylinder 46 and open a fluidic connection between the second gas passageway 58 and the exhaust gas collection apparatus 40 at essentially the same time. Similarly, the switch valve 32 can be any type of valve device that can open a fluidic connection between the high pressure motive gas source 34 and the second gas passageway 58 of the compression cylinder 46 and open a fluidic connection between the first gas passageway 54 and the exhaust gas collection apparatus 40 at essentially the same time. The switch valve 32 can be a single apparatus or a collection of multiple apparatuses. Examples of switch valves can be 5/2 solenoid valves, multiple solenoid valves, such as 3/2 solenoid valves, used in conjunction and/or multiple solenoid spool valves used in conjunction

The present disclosure is also directed to a method of actuating a valve 11 with a high pressure motive gas. The method can include the step of using the high pressure motive gas to act on the diaphragm 26 or the piston 48 to close the valve 11 and using the high pressure motive gas to act on the diaphragm 26 or the piston 48 to open the valve 11. The method also includes the step of directing the vent gas from one of the compression sides of the diaphragm 26 or piston 48 while providing the high pressure motive gas to the opposing side of the diaphragm 26 or piston 48. The method can also include the step of collecting the vent has from the compression chamber 24 or the compression cylinder 46. The method can also include the step of switching the flow of the high pressure motive gas back and forth to open and close the valve 11.

From the above description, it is clear that the present disclosure is well-adapted to carry out the objectives and to attain the advantages mentioned herein as well as those inherent in the disclosure. While presently preferred embodiments have been described herein, it will be understood that numerous changes may be made which will readily suggest themselves to those skilled in the art and which are accomplished within the spirit of the disclosure and claims.

What is claimed is:

1. A valve apparatus for controlling the flow of fluid, the valve apparatus comprising:
a valve having a valve body, a valve inlet for allowing fluid to flow into the valve body, a valve outlet for allowing fluid to flow out of the valve body, a rod element that selectively engages a seat to permit fluid to flow from the valve inlet to the valve outlet; and
a valve actuation apparatus for opening and closing the valve.

2. The apparatus of claim 1 further includes a switch valve to direct a high pressure motive gas from a high pressure motive gas source to the valve actuation apparatus to open and close the valve.

3. The apparatus of claim 2 wherein the switch valve also directs a vent gas generated by the valve actuation apparatus to an exhaust gas collection apparatus.

4. The apparatus of claim 3 wherein the valve actuation apparatus includes:
a compression chamber;
a diaphragm; and
a first gas passage disposed in the compression chamber to permit the high pressure motive gas to enter a first compression side of the diaphragm to act on the diaphragm to force the rod element into the seat of the valve to close or maintain closure of the valve.

5. The apparatus of claim 4 further comprising a second gas passage disposed in the compression chamber on an opposite side of the first gas passage to allow the vent gas to escape a second compression side of the compression chamber when the high pressure motive gas acts on the diaphragm to force the rod element in to the seat of the valve.

6. The apparatus of claim 5 wherein the second gas passage can accept the high pressure motive gas from the switch valve to act on the diaphragm to cause the rod element to disengage the seat of the valve to open the valve and the first gas passageway can direct the vent gas generated on the first compression side of the diaphragm to the switch valve or the exhaust gas collection apparatus.

7. The apparatus of claim 3 wherein the valve actuation apparatus includes:
a compression cylinder;
a piston; and
a first gas passage disposed in the compression cylinder to permit the high pressure motive gas to enter a first compression side of the piston to act on the piston to force the rod element into the seat of the valve to close or maintain closure of the valve.

8. The apparatus of claim 7 further comprising a second gas passage disposed in the compression cylinder on an opposite side of the first gas passage to allow the vent gas to escape a second compression side of the compression cylinder when the high pressure motive gas acts on the piston to force the rod element in to the seat of the valve.

9. The apparatus of claim 8 wherein the second gas passage can accept the high pressure motive gas from the switch valve to act on the piston to cause the rod element to disengage the seat of the valve to open the valve and the first gas passageway can direct the vent gas generated on the first compression side of the piston to the switch valve or the exhaust gas collection apparatus.

10. The apparatus of claim 2 wherein the switch valve can be one or more solenoid valves.

11. A method of opening a closing a valve using high pressure motive gas, the method comprising:
directing a high pressure motive gas to a valve apparatus to open and close a valve.

12. The method of claim 11 wherein the valve apparatus comprises:
a valve having a valve body, a valve inlet for allowing fluid to flow into the valve body, a valve outlet for allowing fluid to flow out of the valve body, a rod element that selectively engages a seat to permit fluid to flow from the valve inlet to the valve outlet; and
a valve actuation apparatus for opening and closing the valve.

13. The method of claim 12 further includes a switch valve to direct a high pressure motive gas from a high pressure motive gas source to the valve actuation apparatus to open and close the valve.

14. The method of claim 13 wherein the switch valve also directs a vent gas generated by the valve actuation apparatus to an exhaust gas collection apparatus.

15. The method of claim 14 wherein the valve actuation apparatus includes:
a compression chamber;
a diaphragm; and
a first gas passage disposed in the compression chamber to permit the high pressure motive gas to enter a first compression side of the diaphragm to act on the diaphragm to force the rod element into the seat of the valve to close or maintain closure of the valve.

16. The method of claim 15 further comprising a second gas passage disposed in the compression chamber on an opposite side of the first gas passage to allow the vent gas to escape a second compression side of the compression chamber when the high pressure motive gas acts on the diaphragm to force the rod element in to the seat of the valve.

17. The method of claim 16 wherein the second gas passage can accept the high pressure motive gas from the switch valve to act on the diaphragm to cause the rod element to disengage the seat of the valve to open the valve and the first gas passageway can direct the vent gas generated on the first compression side of the diaphragm to the switch valve or the exhaust gas collection apparatus.

18. The method of claim 14 wherein the valve actuation apparatus includes:
a compression cylinder;
a piston; and
a first gas passage disposed in the compression cylinder to permit the high pressure motive gas to enter a first compression side of the piston to act on the piston to force the rod element into the seat of the valve to close or maintain closure of the valve.

19. The method of claim 18 further comprising a second gas passage disposed in the compression cylinder on an opposite side of the first gas passage to allow the vent gas to escape a second compression side of the compression cylinder when the high pressure motive gas acts on the piston to force the rod element in to the seat of the valve.

20. The method of claim 19 wherein the second gas passage can accept the high pressure motive gas from the switch valve to act on the piston to cause the rod element to disengage the seat of the valve to open the valve and the first gas passageway can direct the vent gas generated on the first compression side of the piston to the switch valve or the exhaust gas collection apparatus.
